(19) United States
(12) Patent Application Publication
(10) Pub. No.: US 2015/0346363 A1
(43) Pub. Date: Dec. 3, 2015

(54) Method and System for Detecting and Identifying Radioactive Materials

(71) Applicant: Clarksburg Systems, Inc., Clarksburg, MD (US)

(72) Inventor: Yakov SHADYAVICHYUS, Clarksburg, MD (US)

(21) Appl. No.: 14/233,665

(22) PCT Filed: Jun. 12, 2013
(86) PCT No.: PCT/US2013/045329

§ 371 Date: Jan. 17, 2014

(51) Int. Cl. G01T 7/00; G01V 5/00

(52) U.S. Cl. CPC G01T 7/00; G01V 5/00

(57) ABSTRACT

A system for detecting and identifying radioactive materials on board a carrier includes a stationary structure (10) extending lengthwise of the carrier (14) adjacent to at least one of its opposite boards (15). The system also has a plurality of passive radiation detection devices (16) arranged lengthwise of the stationary structure (10). The passive radiation detection devices (16) define a plurality of zones (A through K) extending lengthwise of the stationary structure (10) and each of the passive radiation detection devices (16) is connected to a communication system (a through e) for sending the data containing detection findings obtained within a specific zone within which an increased radioactivity level has been detected by at least one of the passive radiation detection devices a control center (60). The system also has a material identifier (18) capable of identifying radio nuclides and isotopes which emit radiation within the zone within which said increased radioactivity level has been detected. The material identifier (18) is connected to the communication system (a through e) for sending the data containing information on the types of said radioactive materials to the control center (60).

### TECHNICAL FIELD

The disclosure relates to a method and system for detecting and identifying radioactive materials, and more specifically, it deals with radiation monitoring in the transportation sector where radiation monitoring is generally used to detect and identify unregistered (illicit) radioactive items in transit on board of various carriers.

More specifically, the disclosure relates to detection and identification of radioactive materials on board carriers in a broadest meaning of the term “carrier.” For the purposes of the disclosure, the term carrier here stands for any means of transportation containing any variety of cargo items, both bulk and packaged, which monitored as a single whole object or carrier. The inspection in this case is different from inspection of separate containers, truckloads, bundles, and the like, which are normally inspected and/or monitored on a piece-by-piece basis. With this explanation of the term, a “carrier” means, for the purpose of this disclosure, a vessel, an aircraft, a train, or a line (or convoy) of vehicles. Each of these carriers is subjected to the radiation monitoring (i.e., detection and identification of radioactive materials) as one whole item for inspection. The above explanation of the term defines the field of the disclosure.

### BACKGROUND

Systems and methods for detecting clandestine fissile and radioactive materials on the basis of emitted radiation and particles (such as neutrons and alpha particles) arising from within the material are disclosed in US 2013039453 (A1). Emission by the fissile and radioactive material is detected in conjunction with a conventional x-ray imaging system that includes an external source of illuminating penetrating radiation, at least one detector configured to detect at least the penetrating radiation and to generate a detector signal, and a processor configured as a detector signal discriminator to generate an output indicating whether the detector signal is triggered by an origin other than illuminating penetrating radiation. Active and passive modes of detection are described by some embodiments. Other embodiments are directed toward neutron detection, gamma ray detection with energy resolution, and designs of detectors to enhance the detection of clandestine nuclear material. These methods are deficient because they are limited to inspection of a single item of cargo at a time, whether it is a truckload or a container. Such method and systems cannot be used for detection and identification of radioactive materials on board carriers containing a mix of cargo items and bulk loads, e.g., on board of a vessel or aircraft, where it is not practical or even impossible to have access to individual items of and/or compartments containing various loads.

Another known method involves the use of a linear accelerator mounted on a floating platform such as a ship that directs a photon (or comparable) active beam at a target vessel. If the target vessel contains explosives, drugs or a radioactive and/or fissile material, the photon beam will induce characteristic neutron radiation from these substances that is picked up by neutron radiation detectors mounted on the floating platform. Neutron radiation induced by the accelerator is detectable even with a shielding. A flotation stabilization system supports the operation of the accelerator and detectors. The radiation and identification data can be sent to a control center (cf. US 2013039453 (A1)). This method is used for inspecting vessels containing a variety of loads. However, the use of an active device (linear accelerator) for detecting and identifying radioactive materials that may be present on board the vessel that is being inspected has its disadvantages. First, the fact that the detection means is installed on a floating platform requires the use of very sophisticated and very accurate equipment and automation systems in order to ensure an almost zero relative velocity and displacement of the floating platform carrying the detecting/identifying equipment and of the vessel subjected to inspection. If this criterion is not met, the instrumentation on the floating platform will not provide reliable data. Second, the fact that both the vessel that is being inspected and the floating platform are moving during the procedure in the marine environment makes the procedure results vulnerable to many factors that will introduce certain inaccuracies and uncertainties negatively affecting the inspection results. Third, using the active passive detection device without specifically targeting it at an area of the vessel where radioactive materials are supposedly located results in a waste of time and resources. Also, operation of the active device requires a very skilled crew on board the floating platform. In addition, the challenges of communication in the marine environment and the need to consult a database containing the shipping documentation makes the entire system hard to implement for the crew onboard the floating platform. There is critical consideration concerning the use of an active material identification device. In the event that a carrier has weapons-grade nuclear materials on board, the consequences of bombardment of such a load with the accelerated particles might be unpredictable and unwanted. For this reason, the prior art method could be more effectively used for inspecting small vessels such as pleasure boats, tugboats, fishing vessels, and the like.

### SUMMARY OF THE DISCLOSURE

It is an object of the disclosure to provide a method for detecting and identifying radioactive materials which could be used for monitoring/inspecting carriers that contain a variety of cargo items by subjecting a carrier to inspection as a single entity.

This object is accomplished by providing a method for detecting and identifying radioactive materials on board a carrier which includes the steps of positioning the carrier adjacent to a stationary structure, detecting and identifying radioactive materials on board the carrier by means of a plurality of passive radiation detection devices arranged lengthwise of the stationary structure, the passive radiation detection devices defining a plurality of zones extending substantially lengthwise of the stationary structure, and sending the data containing detection findings obtained by the radiation devices within at least one specific zone within which an increased radioactivity level has been detected by at least one of the passive radiation detection devices to a control center. At least one material identifier capable of identifying radio nuclides and isotopes which emit radiation is positioned within the specific zone within which the increased radioactivity level has been detected to identify the radio nuclides and isotopes and to send the data containing information on the types of the radioactive materials to the control center.

The advantages of the method according to the disclosure are as follows.

First, positioning the carrier adjacent to a stationary structure allows for having the same position reference for the carrier and the detection and/or material identification devices (i.e., their relative velocity is practically zero). In addition, the hardware of the detecting and/or material identification devices has plenty of time available for taking the necessary measurements and/or analyses, which are normally required for conducting radiation monitoring measurements (NDT Resource Center. (n.d.). Energy, Activity, Intensity and Exposure. NDT Resource Center) Second, the use of cheaper and simpler passive detection devices (e.g. Thermofisher Scientific (n.d.) Thermo Scientific. FHT 1288 S Modular Radiation Portal Monitors,

Data Sheet) monitoring simultaneously a number of zones along the carrier allows for acquiring data on the presence of any sources of radiation, both legitimate such as NORM and the like and unknown and/or illegitimate (i.e., not reflected in the shipping documents). This step not only provides the time for drawing a conclusion on the presence of sources of radioactivity on board the carrier, but also identifies specific zones of interest within which such sources are located based on the findings of the passive radiation detection devices. The latter facility allows the operator and/or an automated control system to perform the next step of identifying the radioactive materials only within the zone (zones) of interest thus optimally using material identification equipment. This is very important because the equipment used for the material identification step is expensive, complex, and requires very skilled operators (T. Twomey, R. K. (n.d.). Operational Experience with a Secondary Spectroscopic Vehicle Portal Monitor. Oak Ridge, Tenn., 37831 USA: IAEA-CN-184/281).

In addition, it would be very hard and expensive to install and operate a plurality of such units to cover all the zones, especially because such equipment is costly and complex scientific set of instruments, and would require additional complicated measures aimed at making it serviceable in the field, more specifically in the marine environment. It is not even desirable to station such equipment permanently in an area of any traffic or navigation because of a risk of accidental damage to the equipment.

It is known that the major part of world naval traffic, including high-tonnage vessels (tankers, bulk, container carriers, etc.) navigate through two canals, the Suez Canal and the Panama Canal. In both cases, especially in the Panama Canal that has locks, the vessels remain stationary for a substantial amount of time. This provides sufficient time for conducting measurements to detect and identify a source of radioactivity onboard. In this way, detection and identification does not slow down commerce and covers each vessel which enters these canals. Therefore, there is lesser need to apply detection procedures which are inconsistent from one seaport to another (cf. United States Government Accountability Office. (2012, October). Combating Nuclear Smuggling. Megaports Initiative Faces Funding and Sustainability Challenges.). Canal-based screening solution is less costly, not intrusive, can be conducted by well trained and permanent personnel, and as a result will be much more reliable. Besides, it covers not only container vessels which are more often serviced by the port-based detection/identification system, but each boat and ship.

According to the disclosure, the material identification device is brought specifically to a zone where it can be useful, in other words, to the zone where the presence of a radioactive source has already been established as described above. This substantially reduces overall labor effort and particularly skilled labor effort by reducing scanning from hundreds of seaports to several locations, such as e.g. the Panama Canal and other similar areas. This solution will also minimize the residence time of the material identification equipment in the zone exposed to mechanical damage and weather factors. It also reduces the probability and risk of tampering with cargo that might have been taking place after the carrier has left the origination seaport.

The above object is also accomplished by providing a system for detecting and identifying radioactive materials on board a carrier, which includes a stationary structure extending lengthwise of the carrier adjacent to at least one of its opposite boards. The system also has a plurality of passive radiation detection devices arranged lengthwise of the stationary structure. The passive radiation detection devices define a plurality of zones extending lengthwise of the stationary structure and each of the passive radiation detection devices is connected to a communication system for sending the data containing detection findings obtained within a specific zone within which an increased radioactivity level has been detected by at least one of the passive radiation detection devices a control center. The system also has a material identifier capable of identifying radio nuclides and isotopes which emit radiation within the zone within which said increased radioactivity level has been detected, said material identifier being connected to said communication system for sending the data containing information on the types of said radioactive materials to said control center. The use of a material identifier as part of the system which is brought to a specific zone where it will be used is offers a number of advantages. First, if a passive material identifier is used it does not present any danger for the cargo and/or personnel on board the carrier. Second, it will be used in a targeted manner only for a time limited to the amount of time that is necessary to conduct the measurements (but plentifully sufficient to process radioactivity data from the sources present on board and in cargo), which is important because it has to be operated by a skilled physicist and it must be exposed to the risk of mechanical damage and to the elements only for a time that is necessary to conduct the measurements and in a controlled manner.

The fact that the passive radiation detection devices define a plurality of zones lengthwise of the stationary structure, hence, along the carrier, means that a plurality of the passive radiation detection devices can detect the presence or absence of potential sources of radioactivity within all of the zones at a time, with the result that one zone or a plurality of zones will be identified in which an increased radiation level has been recorded. This will reduce the time required to identify suspicious zones and will make it possible to conduct accurately targeted material identification within specific zones that have been identified.

The passive radiation detection devices can be installed on a carrier means for movement lengthwise of the stationary structure. The carrier means can relocate the radiation devices along the carrier from an initial position in which the passive radiation detection devices have already conducted the detection procedure and identified potentially suspicious zones to a next position or to next positions, which define next pluralities of zones. This embodiment of the disclosure allows using a group of a few passive radiation detection devices to cover a carrier of any length within a reasonably short time while lowering the cost of equipment (with fewer passive radiation detection devices used).

In one embodiment of the disclosure, the passive radiation detection devices can be caused to move transversally of the stationary structure, in other words, in the direction toward or away from the carrier. This can be done in order to adjust the position of the passive radiation detection devices with respect to the carrier by taking into account the carrier outlines. This is important because the position of the passive radiation detection devices with respect to the carrier (such as a distance between them and the carrier) is crucial for accuracy of the measurements conducted during the inspection procedure (NDT Resource Center. (n.d.). Energy, Activity, Intensity and Exposure.)

In another embodiment of the disclosure, the material identifier (which can be made as a spectroscopic analyzer) is installed on a vehicle, which can move on the stationary structure along the carrier to any zone of interest. This makes the material identifier completely independent of the entire inspection equipment installation, whereby it can be stationed in an appropriately enclosed (protected and otherwise weather/environment independent) area and can be brought to any suspicious zone of the carrier. The term “vehicle” here means a motor vehicle, a combination of a rail track and car system, or a traveling beam crane, and the like.

It is understood that the above mentioned zones are imaginary zones of the carrier, which are defined along the carrier in accordance with the coverage area of each individual passive radiation detection device. Any method of marking or otherwise clearly identifying such zones can be used for optimal positioning and targeting of the radioactive material identifier, which should be brought to the zones of interest. The marking could be done by using a washable paint sprayed or applied with a brush to leave a mark on the carrier surface. It could be also done digitally using a digital image of the carrier obtained by means of the cameras and sent back to the control center where the image can be processed by applying digital marks to the image. These marking methods do not have any material bearing on the disclosure results.

It is also understood that an active material identifier can be used as well in lieu of a passive material identifier (such as a spectroscopic analyzer), but appropriate measures and safeguards must be put in place in such case (Bjorkholm, P. (2004, 23 9). The X Files).

The method and system of the disclosure do not rely upon the use of an active material identifier.

Although it is understood that the disclosure can be used for any carrier containing a plurality of cargo items (such as a train, a convoy of vehicles, or an aircraft), the description that follows will be given as applied to a carrier which is a vessel, e.g. an ocean container/bulk carrier or any other waterborne vessel.

All the data acquired in conducting the measurements by the passive radiation detection devices and by the material identifier must be processed and evaluated to make decisions—first, on the need to use the material identifier within a specific zone (specific zones) of interest and, second, to draw a conclusion on the presence/absence of radioactive materials on board the carrier. The system has a communication system connected to the passive radiation detection devices and to the material identifier on the one hand and connected to a control center on the other hand. Such communication system can be wired or wireless, or combined. Communication systems and control centers for inspection data collection and processing are known, and they do not have any material bearing on the disclosure. It will be understood that in the simplest applications the data collection and processing can be even done by operators, in which case, the communication system may simply consist of two-way portable communication equipment such as walky-talky.

### BRIEF DESCRIPTION OF THE DRAWINGS

The disclosure will now be described with reference to specific embodiments thereof illustrated in the accompanying drawings, in which:

FIG. 1 is a plan view of a system for detecting and identifying radiation materials according to the disclosure, a top view;

FIG. 2 is an enlarged sectional view of the system of FIG. 1 taken along line I-I, showing a detail of the passive radiation detection device that is movable transversally of the carrier;

FIG. 3 is an embodiment of the disclosure showing the system of FIG. 1, wherein passive radiation detection devices are installed on a movable carrier means;

FIG. 4 is a view of the system of FIG. 2, showing a detail of the passive radiation detection device installed on a movable carrier means.

FIG. 5 is a simplified diagram of a data acquisition and processing system.

### DESCRIPTION

It is very important to note that application of active interrogation devices has the highest potential to advance speed and quality of commerce, which may become not only a source of overall system financing, not only a stimulus to deploy and use comprehensive system of scanning, but would have significant beneficial impact to the entire world trade system, including reduction of tariffs (The Humble Hero: Containers have been more important for globalization than free trade. (2013, 05 18). The Economist, p. 82.). The system can be equipped with multiplicity of readers to monitor integrity of locked containers (obviously, if these containers were outfitted with electronic locks). Similar reading can be performed by tracking certain specific tagged items. At the same location, it is possible to deploy powerful Infrared tools and/or ultrasound devices to inspect containers and bulk/ro-ro vessels. Ultimately, if on both sides of a vessel the system uses powerful linear accelerator equipment, it is possible, similarly to x-ray technique, to verify content of the containers (see Bjorkholm, P. (2004, 23 9). The X Files. Retrieved 05 14, 2013, from The X Files: Part 3: http://www.varian.com/media/security_and_inspection/resources/articles/pdf/The_X_Files_Part_{—}3.pdf). The more such inspection methodologies are perfected, the more precise understanding of container and cargo content and integrity the system will develop. Applying proper Customs procedures by comparing and studying all the cargo and vessel-related data, it is quite feasible that cargo inspection and tax assessments would be satisfactorily performed by using the canal-based monitoring system and comparing its data to all other proper documents. According to The Economist (ibidem), such cargo verification may reduce world tariffs by app. 50%.

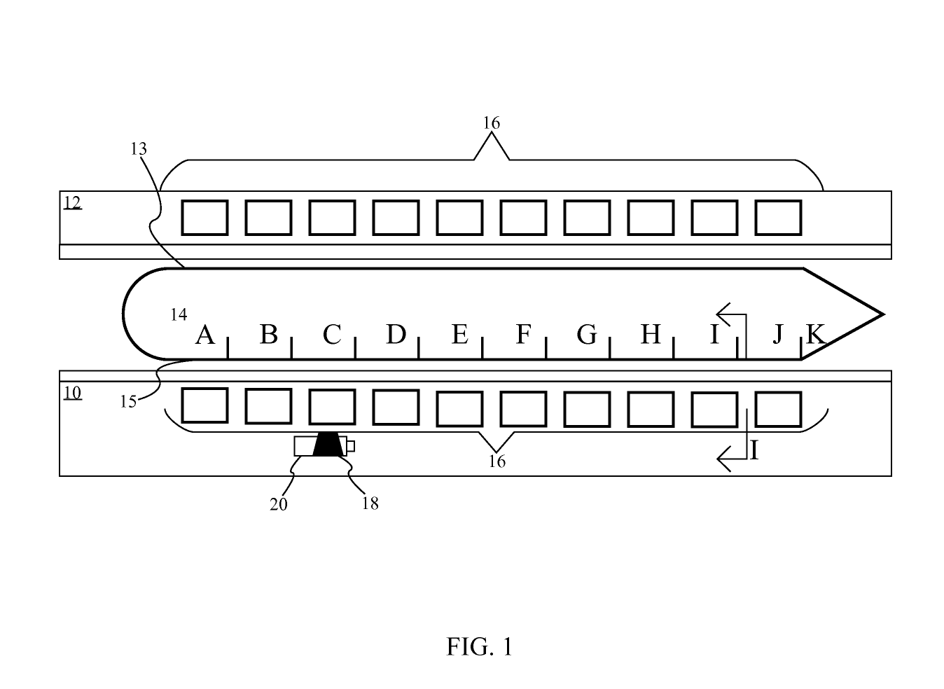

With reference to FIG. 1, a system for detecting and identifying radioactive materials according to the disclosure has at least one stationary structure 10, 12. The structure may be in the form of a part of a lock, canal embankment, parts of a lowered caisson, a sea wall and the like, or even a stationary vessel or a line of stationary vessels in case that is practicable. In the event a carrier is train, the stationary structure may be in the form of a platform.

A carrier 14, more specifically a vessel, is positioned adjacent to and lengthwise of the stationary structures 10, 12. The carrier 14 has opposite boards 13, 15. A plurality of passive radiation detection devices 16 are installed on the stationary structures 10, 12 lengthwise thereof, hence lengthwise of the carrier 14 and defines a plurality of zones A through K lengthwise of the stationary structure 10, 12, hence lengthwise of the carrier 14. In the event that the passive radiation detection devices 16 are permanently installed along the entire carrier 14 as shown FIG. 1, there is no need to mark the zones on the carrier. The system also has a material identifier 18 which is installed on a vehicle 20. The vehicle can move around on the stationary structure 10 for bringing the material identifier 18 to any zone of the zones a through K which is the zone of interest as it will be explained later. The material identifier 18 is shown located only on one of the stationary structures, the stationary structure 10 as shown in FIG. 1, but it is understood that a similar device can be located on the other stationary structure 12.

It is feasible to use a material identifier on only one side of the vessel if, for instance, the radiation level detected by the detectors is very strong on one side, and negligible or not detected at all on the other side. Also, if it is not e.g. a lock or a lowered caisson with two embankments, but a pier with only one embankment and the entire system is positioned only on one side of a vessel, then the detection and identification devices will be located only on one side of the carrier. It is understood that the vehicle 20 with the material identifier 18 may be stationed (kept) in an enclosed location (not shown) from which it can be relocated to any zone of interest of the zones A through K for taking measurements. The material identifier may be in the form of a spectroscopic analyzer (e.g.: SAIC. (n.d.). EXPLORANIUM® ST-20 Radiation Portal Monitor. SAIC Security and Transportation Technology or FEMA. (n.d.). CANBERRA Germanium Spectroscopic Portal Monitor.FEMA:)

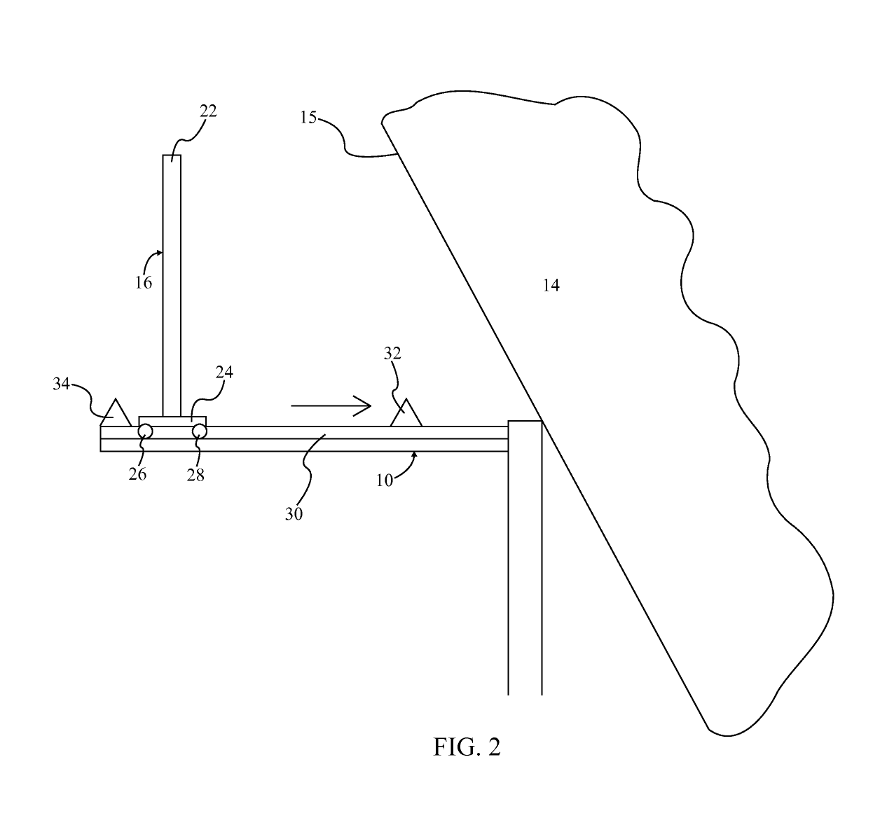

With reference to FIG. 2, the passive radiation detection device 16 has a panel 22 (which accommodates all measuring and communication instrumentation), which is installed on a base 24 supported by rollers 26, 28. The rollers 26, 28 are installed for rolling along a track 30, which is installed on the stationary structure 10 substantially transversely of the stationary structure 10, hence transversely of the carrier 14. The track 30 has stops 32, 34 for limiting the movement of the base 24 supporting the panel 22 of the passive radiation detection device 16. It will be understood that the panel 22 of the passive radiation detection device 16 can be moved toward and away from the board 15 of the carrier 14 in order to obtain the best measurement conditions. When each of the plurality of the passive radiation detection devices 16 is arranged as shown in FIG. 2, each of the individually can be moved to the best position with respect to the board 13, 15 of the carrier 14 for conducting the measurements in the best conditions.

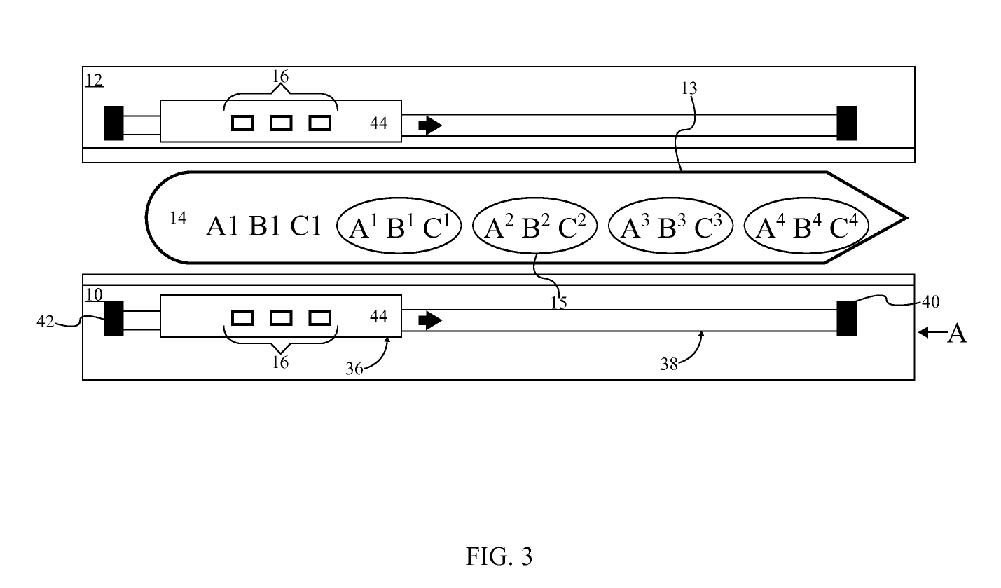

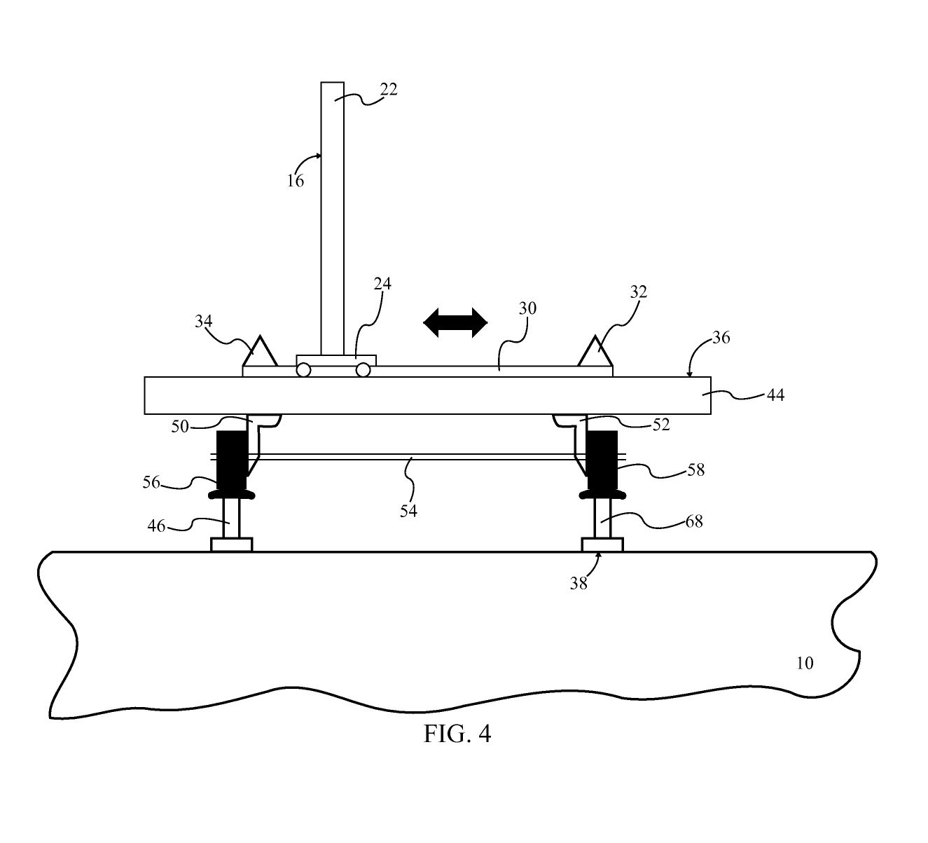

With reference to FIG. 3, the passive radiation detection devices 16 (in this case three passive radiation detection devices 16) are installed on a carrier means 36, which is positioned lengthwise of the stationary structure 10, 12 form movement lengthwise of the on track 38 The track 38 has stops 40, 42 for limiting the travel of the carrier means 36, which is made as a platform 44 as shown in FIG. 4. The track 38 is made of two rails 46, 48, which are installed on the stationary structure 10. The platform 44 has brackets 50, 52 attached to the underside of the platform and an axle 54 journalled in the brackets 50, 52 and having wheels 56, 58, which are installed on the rails 46, 48. It is understood that that platform has at least another pair of brackets 50, 52 and wheels 56, 58 with the axle 54 spaced from the wheels 56, 58 shown in FIG. 4 lengthwise of the platform 44, hence lengthwise of the permanent structure. With this arrangement, when the platform 44 of the carrier means 36 is caused to move along the track 38 (by any means that is not shown, which may include by hands) the passive radiation detection devices 16 will move with the platform lengthwise of the stationary structure 10, hence lengthwise of the carrier 14. When the carrier means 36 (FIG. 3) is in the initial position as shown, the three passive radiation detection devices 16 define three zones A through C within which radiation is measured by the panels 22 (FIG. 4). This is done after the passive radiation detection devices 16 are each moved along the track 30 toward or away from the board 15 of the carrier 14 (FIG. 2) for better measurement conditions. After the measurements have been completed in the initial position shown in FIG. 3, the carrier means 36 will be moved lengthwise of the stationary structure 10 by moving the platform 44 on the wheels 56, 58 along the track 38, hence lengthwise of the carrier 14 to a next position in which new zones A^{l} through C¹ will be designed lengthwise of the stationary structure, hence lengthwise of the carrier 14, and new measurements will be conducted as described above. The platform 44 will be then moved again to a new position, and so on, until the measurements have been completes within the last zones A⁴ through C⁴. It will be understood, that after the measurements have been completed by the passive radiation detection devices 16 in the system embodiment shown in FIG. 1, a zone or zones from among the zones A through K will be discovered within which an increased radiation level has been recorded. The vehicle 20 carrying the material identifier 18 such as a spectroscopic analyzer will then be moved to a point within the zone or zones of interest, and the analysis will be run to identify radio nuclides or isotopes that are present in the zone or zones of interest in a known per se manner (Canberra Industries, Inc. (n.d.). Spectrum Analysis.). The same is done in the embodiment shown in FIG. 3, but in this case, the vehicle 20 carrying the material identifier 18 can be moved to one of zones A^{l} through C¹ corresponding to the initial position of the carrier means 36 right immediately after the measurements have been completed in the initial position. After the analysis has been completed within the zones A^{l} through C¹, the vehicle 20 will be ready to move to the next zones A² through C² corresponding to the next position of the carrier means 36, provided a zone of interest has been encountered in the next position. The measurement cycle will be repeated after each movement of the passive radiation detection devices 16 on the carrier means 36 to each next position.

It will be understood from the above description of the preferred embodiments of the disclosure, the above-described system for detecting and identifying radioactive materials is used to carry out a method for detecting and identifying radioactive materials that substantially includes the steps of, first, detecting the presence of radioactive materials on board the carrier 14 that is stopped at the stationary structure 10 by using passive radiation detection devices arranged lengthwise of the stationary structure to define a plurality of zones lengthwise of the stationary structure A through K. The method further includes using a material identifier to identify the radioactive materials within a zone or zones of the zones A through within which an increased radiation level has been recorded.

It will be understood that the gist of the method is to conduct simultaneous radiation detection measurement within a plurality of zones of the carrier 14 or within a plurality of zones of at least a part of the carrier 14, with subsequent material identification conducted only within the zone or zones of interest within which an increased radiation level has been recorded.

As mentioned above, the data obtained during measurements conducted by means of the passive radiation detection devices 16 and, subsequently, during the measurements conducted by means of the material identifier 18 are transferred to a control center via a communication system, which is connected to the passive radiation detection devices 16 and to the material identifier 18 on the one side and to the control center on the other side.

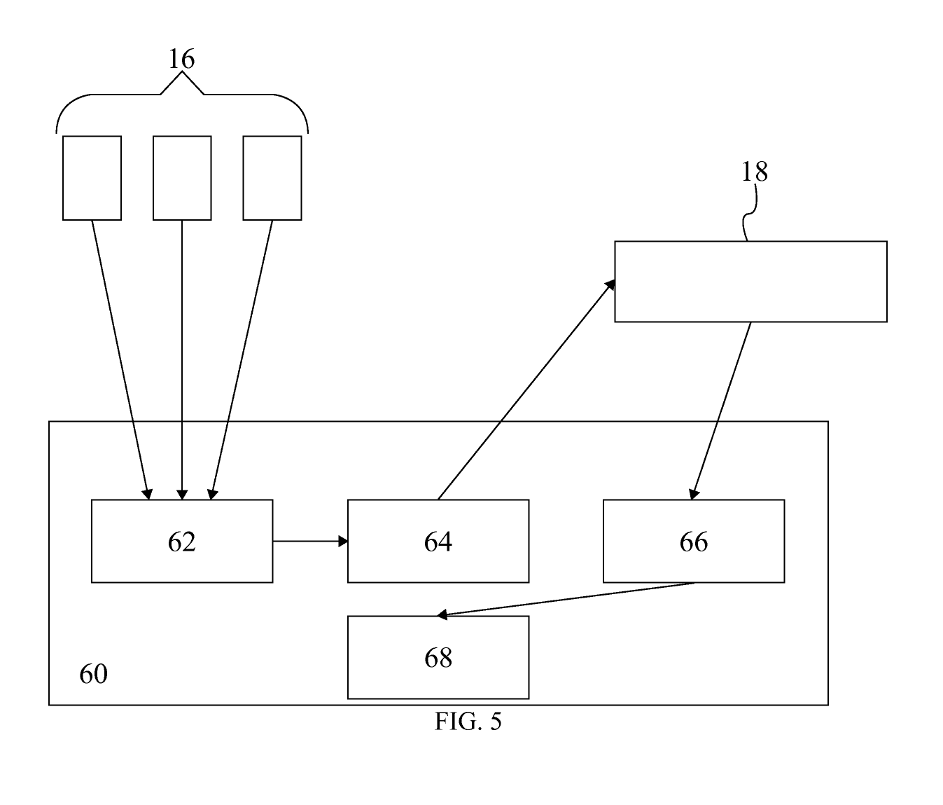

FIG. 5 shows is a simplified diagram of a data acquisition and processing system for carrying out the method according to the disclosure.

A control center 60 has a radiation detection data receiver and processor 62 connected to the passive radiation detection devices 16 to receive the data on radiation levels detected within specific zones A through K. A signal from each radiation detector 16 contains the radiation level and a zone marker. The data from the passive radiation detection devices are received and processed in radiation detection data receiver and processor 62 in which the radiation levels are compared to the reference/background levels or to any other preset values specified for a particular type of carrier. If the comparison results exceed the predetermined threshold, the radiation detection data receiver and processor 62 outputs the comparison results containing the respective zone marks to an output module 64, which sends a signal that signifies an increased radiation level in the specific zones A through K within which the radiation level that has been recorded by the passive radiation detection devices 16 exceeded the specified limit. The output module 64 sends commands containing the zone marks to the material identifier 18 for conducting the material identification analysis. The commands to the identifier may be in the form of signals controlling an operator's interface display installed in the vehicle 20 that carries the material identifier 18. If the material identifier is installed on a cart moving along a track under control of an automated system, these commands will go directly to a module that controls the cart movement. The analysis results are sent from the material identifier 18 to an input module and processing 66 of the control center 60 in the form of a spectrum showing the spectroscopic analysis results. The input module may be in the form of an automatic digital spectrogram reader (Twomey, T., R. K. (n.d.). Operational Experience with a Secondary Spectroscopic Vehicle Portal Monitor. Oak Ridge, Tenn., 37831 USA: IAEA-CN-184/281.), or it may be simply a specialist who can review the analysis results. With any arrangement, the analysis results are sent, after processing in the module 66, to a decision-making module 68 for drawing a conclusion on admissibility of the contents of cargo onboard the carrier 14. The communication system between the fielded system elements and potentially higher level data users is shown in FIG. 5.

The data acquisition and processing system passive radiation detection devices 16 and the material identifier 18 on the one side and the control center 60, more specifically, the receiver and process 62, the output module 64, the input and processing module 66, is illustrated by arrows in the diagram. The arrows a through e show schematically a communications system for wired and/or wireless connections between the various elements of the system, which is immaterial for the present disclosure.

It will be understood that the above described communication system and the arrangement of the control center may be different and may include various degrees of automation and/or computerization without, however, having any effect on the result obtained by using the present disclosure.

It will be understood that many modifications and changes can be made to the method and system according to the disclosure without going beyond the spirit and scope of the disclosure as defined in the attached claims.

Thus, instead of using the carrier means 36 for moving the passive radiation detection devices 16, the carrier itself can be moved each time to expose different zones thereof to the passive radiation detection device 16. The material identifier 18 can be installed on carrier means 36 in an appropriate enclosure to conduct measurements in the zones of interest immediately after an increased radiation level has been recorded. This and other potential changes and modifications will be within the range of equivalents.

I claim:

1. A method for detecting and identifying radioactive materials on board a carrier having opposite boards, said method comprising:
positioning said carrier adjacent to at least one stationary structure;
detecting and identifying radioactive materials on board said carrier by means of a plurality of passive radiation detection devices arranged lengthwise of at least one of said stationary structures, said passive radiation detection devices defining a plurality of zones extending substantially lengthwise of said at least one stationary structure, said plurality of passive radiation detection devices sending the data containing detection findings obtained within at least one specific zone of said plurality of zones within which an increased radioactivity level has been detected by at least one of said passive radiation detection devices to a control center;
positioning at least one material identifier that is capable of identifying radio nuclides and isotopes which emit radioactivity within said at least one specific zone within which said increased radioactivity level has been detected, identifying said radio nuclides and isotopes, and sending the data containing information on the types of said radioactive materials to said control center.

2. The method for detecting and identifying radioactive materials of claim 1, comprising positioning said carrier between at least two stationary structures extending adjacent to said opposite boards.

3. The method for detecting and identifying radioactive materials of claim 1, comprising using a plurality of passive radiation detection devices arranged lengthwise of said at least one stationary structure and detecting the presence of radioactive material within said plurality of zones in an initial position, relocating said plurality of passive radiation detection devices to new positions, each of said new positions defining a new plurality of zones lengthwise of said at least one stationary structure, detecting and identifying radioactive materials on board said carrier by means of said passive radiation detection devices of said plurality of passive radiation detection devices when in each of said new positions, and sending the data containing detection findings obtained within at least one specific zone of said plurality of zones in said initial position and in said new positions.

4. The method for detecting and identifying radioactive materials of claim 1, wherein said material identifier comprises a spectroscopic analyzer.

5. A method for detecting and identifying radioactive materials on board a carrier, said method comprising:
positioning said carrier adjacent to at least one stationary structure;
detecting and identifying radioactive materials on board said carrier by means of a plurality of passive radiation detection devices arranged lengthwise of at least one of said stationary structures, said passive radiation detection devices defining a plurality of zones lengthwise of said at least one stationary structure, said plurality of passive radiation detection devices sending the data containing detection findings obtained within at least one specific zone of said plurality of zones within which an increased radioactivity level has been detected by at least one of said passive radiation detection devices to a control center;
positioning at least one spectroscopic analyzer for identifying radio nuclides and isotopes which emit radioactivity within said at least one specific zone within which said increased radioactivity level has been detected, identifying said radioactive materials, and sending the data containing information on the types of said radioactive materials to said control center.

6. The method for detecting and identifying radioactive materials of claim 5, comprising positioning said carrier between at least two stationary strictures located opposite to the carrier boards.

7. A method for detecting and identifying radioactive materials on board a carrier, said method comprising:
positioning said carrier between at least two stationary strictures extending adjacent to said opposite boards;
using a plurality of passive radiation detection devices arranged lengthwise of at least one of said at least two stationary structures and detecting the presence of radioactive material within said plurality of zones in an initial position, relocating said plurality of passive radiation detection devices to new positions, each of said new positions defining a new plurality of zones lengthwise of said at least one of said at least two stationary structures, detecting and identifying radioactive materials on board said carrier by means of said passive radiation detection devices of said plurality of passive radiation detection devices when in each of said new positions, and sending the data containing detection findings obtained within at least one specific zone of said plurality of zones in said initial position and in said new positions;
positioning at least one material identifier for identifying radio nuclides and isotopes which emit radioactivity within said at least one specific zone within which said increased radioactivity level has been detected, identifying said radio nuclides and isotopes, and sending the data containing information on the types of said radioactive materials to said control center.

8. The method for detecting and identifying radioactive materials of claim 7, wherein said material identifier comprises a spectroscopic analyzer.

9. A system for detecting and identifying radioactive materials on board a carrier having opposite boards, comprising radiation detecting means for detecting the presence of radiation materials on board said carrier, said detecting means being arranged adjacent to said carrier, a communication system, and a control center, said communication system being linked to said radiation detecting means and to said control center, wherein:
said system comprises at least one stationary structure extending lengthwise of said carrier adjacent to at least one of said opposite boards;
said radiation detection means comprises a plurality of passive radiation detection devices arranged lengthwise of said at least one stationary structure, said passive radiation detection devices defining a plurality of zones extending substantially lengthwise of said at least one stationary structure, each of said plurality of passive radiation detection devices being connected to said communication system for sending the data containing detection findings obtained within at least one specific zone of said plurality of zones within which an increased radioactivity level has been detected by at least one of said passive radiation detection devices to said control center;
said system further comprises at least one material identifier that is capable of identifying radio nuclides and isotopes which emit radioactivity within said at least one specific zone within which said increased radioactivity level has been detected, said material identifier being connected to said communication system for sending the data containing information on the types of said radioactive materials to said control center.

10. The system for detecting and identifying radioactive materials of claim 9, wherein at least one of said radiation detecting devices is movable in the direction substantially transversely of said at least one stationary structure.

11. The system for detecting and identifying radioactive materials of claim 9, wherein said material identifier is mounted on a vehicle movable at least along said at least one stationary structure.

12. The system for detecting and identifying radioactive materials of claim 11, wherein at least one of said radiation detecting devices is movable in the direction substantially transversely of said at least one stationary structure.

13. A system for detecting and identifying radioactive materials on board a carrier having opposite boards, comprising a plurality of radiation detecting means for detecting the presence of radiation materials on board said carrier, said detecting means being arranged adjacent to said carrier, a communication system, and a control center, said communication system being linked to said detecting means and to said control center, wherein:
said system comprises at least one stationary structure extending lengthwise of said carrier adjacent to at least one of said opposite boards;
said detection means comprises a plurality of passive radiation detection devices and a carrier means, said passive radiation detection devices being installed on said carrier means which is movable from an initial position in which it defines a plurality of zones lengthwise of said at least one stationary structure to new positions, each of said new positions defining said plurality of zones lengthwise of said at least one stationary structure for detecting and identifying radioactive materials on board said carrier in each of said initial position and said new positions, each of said plurality of passive radiation detection devices being connected to said communication system for sending the data containing detection findings obtained within at least one specific zone of said plurality of zones within which an increased radioactivity level has been detected by at least one of said passive radiation detection devices to said control center;
said system further comprises at least one material identifier that is capable of identifying radio nuclides and isotopes which emit radioactivity within said at least one specific zone within which said increased radioactivity level has been detected, said material identifier being connected to said communication system for sending the data containing information on the types of said radioactive materials to said control center.

14. The system for detecting and identifying radioactive materials of claim 13, wherein at least one of said radiation detecting devices is movable in the direction substantially transversely of said at least one stationary structure.

15. The system for detecting and identifying radioactive materials of claim 13, wherein said material identifier is mounted on a vehicle movable at least along said at least one stationary structure.

16. The system for detecting and identifying radioactive materials of claim 15, wherein at least one of said radiation detecting devices is movable in the direction substantially transversely of said at least one stationary structure.

17. A system for detecting and identifying radioactive materials on board a carrier having opposite boards, comprising a radiation detecting means for detecting the presence of radiation materials on board said carrier, said detecting means being arranged adjacent to said carrier, a communication system, and a control center, said communication system being linked to said detecting means and to said control center, wherein:
said system comprises at least one stationary structure extending lengthwise of said carrier;
said radiation detection means comprises a plurality of passive radiation detection devices and a carrier means, said passive radiation detection devices being installed on said carrier means which is movable from an initial position in which it defines a plurality of zones lengthwise of said at least one stationary structure to new positions, each of said new positions defining said plurality of zones lengthwise of said at least one stationary structure for detecting and identifying radioactive materials on board said carrier in each of said initial position and said new positions, each of said plurality of passive radiation detection devices being connected to said communication system for sending data containing detection findings obtained within at least one specific zone of said plurality of zones within which an increased radioactivity level has been detected by at least one of said passive radiation detection devices to said control center;
said system further comprises at least one spectroscopic analyzer for identifying radio nuclides and isotopes which emit radioactivity within said at least one specific zone within which said increased radioactivity level has been detected, said spectroscopic analyzer being connected to said communication system for sending the data containing information on the types of said radioactive materials to said control center.

18. The system for detecting and identifying radioactive materials of claim 17, wherein at least one of said radiation detecting devices is movable in the direction substantially transversely of said at least one stationary structure.

19. The system for detecting and identifying radioactive materials on board a carrier of claim 13, wherein said spectroscopic analyzer is mounted on a vehicle movable at least along said at least one stationary structure.

20. The system for detecting and identifying radioactive materials on board a carrier of claim 19, wherein at least one of said radiation detecting devices is movable transversely of at least one said stationary structure.

21. A system for detecting and identifying radioactive materials on board a carrier having opposite boards, comprising radiation detecting means for detecting the presence of radiation materials on board said carrier, said detecting means being arranged adjacent to said carrier, a communication system, and a control center, said communication system being linked to said detecting means and to said control center, wherein:
said system comprises at least two stationary structures extending lengthwise of and adjacent to said opposite boards of said carrier;
said radiation detection means comprises a plurality of passive radiation detection devices arranged lengthwise of at least one of said at least two stationary structures, said passive radiation detection devices defining a plurality of zones extending substantially lengthwise of said at least one of said at least two stationary structures, each of said plurality of passive radiation detection devices being connected to said communication system for sending the data containing detection findings obtained within at least one specific zone of said plurality of zones within which an increased radioactivity level has been detected by at least one of said passive radiation detection devices to said control center;
said system further comprises at least one material identifier that is capable of identifying radio nuclides and isotopes which emit radioactivity within said at least one specific zone within which said increased radioactivity level has been detected, said material identifier being connected to said communication system for sending the data containing information on the types of said radioactive materials to said control center.

22. The system for detecting and identifying radioactive materials of claim 21, wherein at least one of said radiation detecting devices is movable in the direction substantially transversely of said at least one if said at least two stationary structures.

23. The system for detecting and identifying radioactive materials of claim 21, wherein said material identifier is mounted on a vehicle movable at least along said at least two of stationary structures.

24. The system for detecting and identifying radioactive materials of claim 23, wherein at least one of said radiation detecting devices is movable in the direction substantially transversely of said at least one if said at least two stationary structures.

25. A system for detecting and identifying radioactive materials on board a carrier having opposite boards, comprising radiation detecting means for detecting the presence of radiation materials on board said carrier, said detecting means being arranged adjacent to said carrier, a communication system, and a control center, said communication system being linked to said detecting means and to said control center, wherein:
said system comprises at least two stationary structures extending lengthwise of and adjacent to said opposite boards of said carrier;
said radiation detection means comprises a plurality of passive radiation detection devices arranged lengthwise of one of said at least two stationary structures, said passive radiation detection devices defining a plurality of zones extending substantially lengthwise of said at least one of said at least two stationary structures, each of said plurality of passive radiation detection devices being connected to said communication system for sending the data containing detection findings obtained within at least one specific zone of said plurality of zones within which an increased radioactivity level has been detected by at least one of said passive radiation detection devices to said control center;
said system further comprises at least one spectroscopic analyzer for identifying radio nuclides and isotopes which emit radioactivity within said at least one specific zone within which said increased radioactivity level has been detected, said material identifier being connected to said communication system for sending the data containing information on the types of said radioactive materials to said control center.

26. The system for detecting and identifying radioactive materials of claim 25, wherein at least one of said radiation detecting devices is movable in the direction substantially transversely of said at least one if said at least two stationary structures.

27. The system for detecting and identifying radioactive materials of claim 25, wherein said material identifier is mounted on a vehicle movable at least along said at least two of stationary structures.

28. The system for detecting and identifying radioactive materials of claim 27, wherein at least one of said radiation detecting devices is movable in the direction substantially transversely of said at least one if said at least two stationary structures.

29. A system for detecting and identifying radioactive materials on board a carrier having opposite boards, comprising detecting means for detecting the presence of radiation materials on board said carrier, said detecting means being arranged adjacent to the carrier, a communication system, and a control center, said communication system being linked to said detecting means and to said control center, wherein:
said systems comprises at least two stationary structures extending lengthwise of and adjacent to said opposite boards;
said detection means comprises a plurality of passive radiation detection devices and a carrier means, said passive radiation detection devices being installed on said carrier means which is movable from an initial position in which it defines a plurality of zones lengthwise of said one of said at least two stationary structures to new positions, each of said new positions defining said plurality of zones lengthwise of said at least one of said at least two stationary structures for detecting and identifying radioactive materials on board said carrier in each of said initial position and said new positions, each of said plurality of passive radiation detection devices being connected to said communication system for sending the data containing detection findings obtained within at least one specific zone of said plurality of zones within which an increased radioactivity level has been detected by at least one of said passive radiation detection devices to said control center;
said system further comprises at least one material identification device that is capable of identifying radio nuclides and isotopes which emit radioactivity within said at least one specific zone within which said increased radioactivity level has been detected, said material identification device being connected to said communication system for sending the data containing information on the types of said radioactive materials to said control center.

30. The system for detecting and identifying radioactive materials of claim 29, wherein at least one of said radiation detecting devices is movable in the direction substantially transversely of said at least one if said at least two stationary structures.

31. The system for detecting and identifying radioactive materials of claim 29, wherein said material identifier is mounted on a vehicle movable at least along said at least two of stationary structures.

32. The system for detecting and identifying radioactive materials of claim 31, wherein at least one of said radiation detecting devices is movable in the direction substantially transversely of said at least one if said at least two stationary structures.

33. A system for detecting and identifying radioactive materials on board a carrier having opposite boards, comprising detecting means for detecting the presence of radiation materials on board said carrier, said detecting means being arranged adjacent to the carrier, a communication system, and a control center, said communication system being linked to said detecting means and to said control center, wherein:
said systems comprises at least two stationary structures extending lengthwise of and adjacent to said opposite boards;
said detection means comprises a plurality of passive radiation detection devices and a carrier means, said passive radiation detection devices being installed on said carrier means which is movable from an initial position in which it defines a plurality of zones lengthwise of said one of said at least two stationary structures to new positions, each of said new positions defining said plurality of zones lengthwise of said at least one of said at least two stationary structures for detecting and identifying radioactive materials on board said carrier in each of said initial position and said new positions, each of said plurality of passive radiation detection devices being connected to said communication system for sending the data containing detection findings obtained within at least one specific zone of said plurality of zones within which an increased radioactivity level has been detected by at least one of said passive radiation detection devices to said control center;
said system further comprises at least one spectroscopic analyzer for identifying radio nuclides and isotopes which emit radioactivity within said at least one specific zone within which said increased radioactivity level has been detected, said spectroscopic analyzer being connected to said communication system for sending data containing information on the types of said radioactive materials to said control center.

34. The system for detecting and identifying radioactive materials of claim 33, wherein at least one of said radiation detecting devices is movable in the direction substantially transversely of said at least one if said at least two stationary structures.

35. The system for detecting and identifying radioactive materials of claim 33, wherein said material identifier is mounted on a vehicle movable at least along said at least two of stationary structures.

36. The system for detecting and identifying radioactive materials of claim 35, wherein at least one of said radiation detecting devices is movable in the direction substantially transversely of said at least one if said at least two stationary structures.
